(19) United States
(12) Patent Application Publication
(10) Pub. No.: US 2014/0324569 A1
(43) Pub. Date: Oct. 30, 2014

(54) METHOD AND SYSTEM TO MEDIATE SELECTION OF CHOICE PRESENTATION MODELS

(71) Applicant: LinkedIn Corporation, Mountain View, CA (US)

(72) Inventors: Jacob Kessler, Palo Alto, CA (US); Bin Pan, Belmont, CA (US); Tong (Bruce) Yang, Mountain View, CA (US)

(73) Assignee: LinkedIn Corporation, Mountain View, CA (US)

(21) Appl. No.: 13/869,836

(22) Filed: Apr. 24, 2013

(51) Int. Cl. G06Q 30/02

(52) U.S. Cl. CPC G06Q 30/0244; G06Q 30/0251
USPC 705/14.43

(57) ABSTRACT

A method and system to mediate selection of choice presentation models are described. A models mediator, implemented using software, hardware or both, may be configured to exercise different choice presentation models, collect and analyze information with respect to how well each model performed in succeeding to convince a respective user to purchase one of the presented subscription plans, and determine how frequently each model should be used to generate a presentation of subscription choices.

### TECHNICAL FIELD

This application relates to the technical fields of software and/or hardware technology and, in one example embodiment, to a system and method to mediate selection of choice presentation models.

### BACKGROUND

A provider of a web-based service (e.g., a provider of a social networking website or a provider of an on-line trading platform) may offer users access to basic features of the service free of charge, but require a for-fee subscription to a version of the service that includes additional or enhanced features. A user may be presented with a message briefly describing an enhanced version of the service. The user may choose to purchase the offered subscription or decline and continue to use the free version of the service.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to mediate selection of choice presentation models may be implemented;

FIG. 2 is block diagram of a subscription system, in accordance with one example embodiment;

FIG. 3 is block diagram of a system to mediate selection of choice presentation models, in accordance with one example embodiment;

FIG. 4 is a flow chart of a method to mediate selection of choice presentation models, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to mediate selection of choice presentation models are described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

As mentioned above, a provider of a web-based service, such as, e.g., a provider of a social networking website, may offer various for-fee subscription plans to users. The subscription plans offered by a provider of a social networking website may differ in the feature sets, the quality of service, as well as in price. Where a provider of a social networking website is offering a number of different subscription plans, and especially where the number of available subscription plans is greater than just a few, the provider may face a challenge of deciding which plans to suggest to a potential subscriber and in which order the suggested plans are to be presented. One goal of the provider may be to select the suggested subscription plans in a way that would make it more likely that the user purchases one of the plans. For example, a provider may wish to know whether a user is more likely to purchase a subscription plan that is presented next to a more expensive plan or whether a user is more likely to purchase a subscription plan that is presented together with both a less expensive plan and a much more expensive plan. A provider may also wish to be able to predict, which feature or features of their service may be important enough to a particular user in order to purchase a particular plan. Also, a provider may wish to be able to predict, what characteristics of a particular user may be indicative of that user being potentially interested in purchasing a certain subscription plan.

In order to address these questions, a so-called subscription system may be provided. A subscription system, in one example embodiment, may have access to one or more subscription plans, to profiles of users who may be potential subscribers, as well as to data collected with respect to the users' activities on the social networking website. An example subscription system may include one or more of choice presentation models. A choice presentation model, in one example embodiment, is a tool, implemented using software, hardware or both, that may be configured to analyze data associated with a user who is the intended recipient of the presentation of the subscription plans options and generate, automatically, a presentation of subscription choices. A choice presentation model, also referred to as merely “a model,” may be configured to utilize pre-determined rules for generating presentations of subscription choices, which may be referred to as a rules-based approach. In some embodiments, choice presentation model may use machine-learning techniques where the data obtained as a result of presenting the user with the subscription choices is utilized by the model to adjust its methods for generating future presentations of subscription choices.

In one example embodiment, where a subscription system includes a plurality of models, the subscription system may also include a so-called models mediator. A models mediator, implemented using software, hardware or both, may be configured to exercise different choice presentation models, collect and analyze information with respect to how well each model performed in succeeding to convince a respective user to purchase one of the presented subscription plans, and determine how frequently each model should be used to generate a presentation of subscription choices.

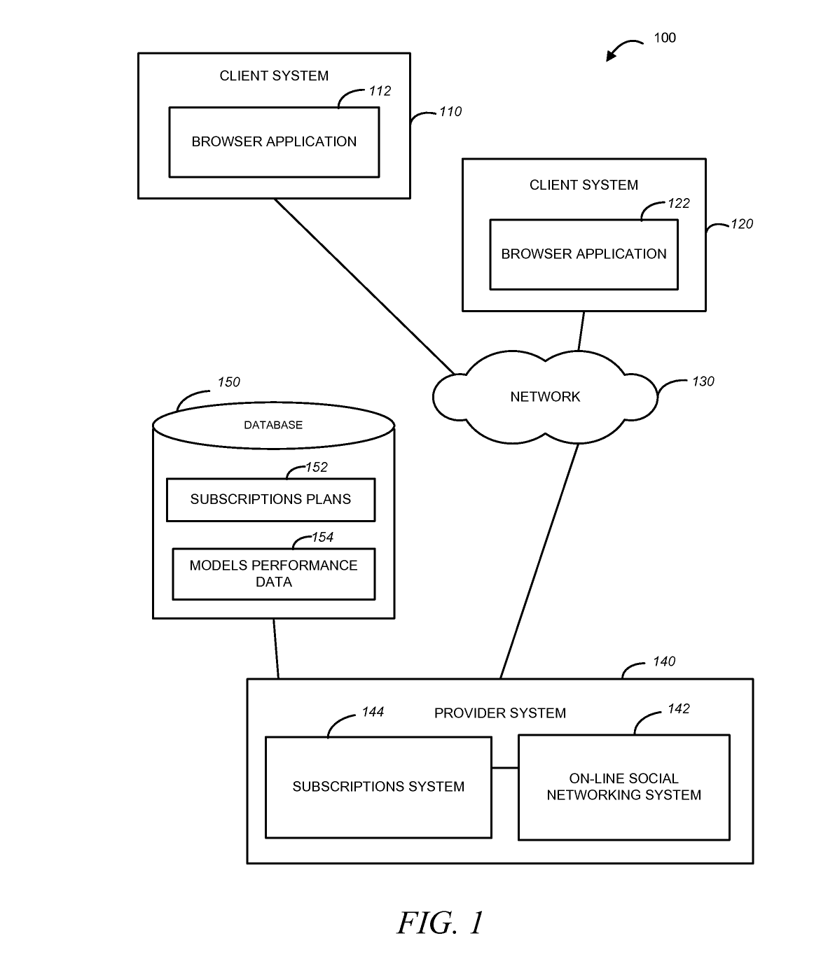

For example, if the subscription system includes three models, each of which is based on a different approach for generating a presentation of subscription choices for a specific user, a models mediator may start out by assigning each model an equal portion of traffic. The term “traffic” is used here to mean the events that may occur on the associated social networking website that are designated as triggering events for presenting a user with subscription choices. A triggering event may be any predetermined event on the associated social networking website that is considered as indicative of a user's potential interest in purchasing a subscription, such as, e.g., a user attempting to access a for-fee feature provide by the social networking website. An example method and system to mediate selection of choice presentation models may be implemented in the context of a network environment 100 illustrated in FIG. 1.

As shown in FIG. 1, the network environment 100 may include client systems 110 and 120 and a provider system 140. The provider system 140, in one example embodiment, may host an on-line trading platform. The client systems 110 and 120 may run respective browser applications 112 and 122 and may have access to the provider system 140 via a communications network 130. The communications network 130 may be a public network (e.g., the Internet, a mobile communication network, or any other network capable of communicating digital data).

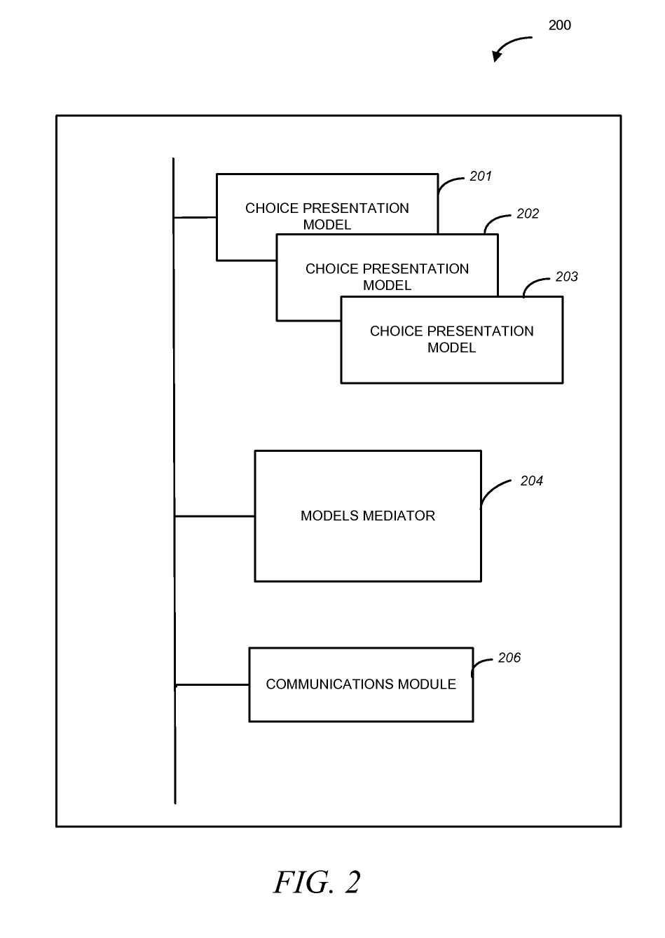

The client system 110 may utilize the browser application 112 to access services provided by the provider system 140. For example, the provider system 140 may host an on-line social networking system 142, e.g., a business-oriented social networking site. As shown in FIG. 1, the system 142 is associated with a subscription system 144. The subscription system 144 may be used in the context of and together with the on-line social networking system 142 to aid in determining, automatically, which plans to suggest to a potential subscriber of the on-line social networking system 142 and in which order the suggested plans are to be presented to the potential subscriber. The subscription system 144 and the on-line social networking system 142 have access to a database 150 that stores subscription plans 152 and model performance data 154. In one embodiment, the models may be compared on a variety of metrics, both short and long term, including direct revenue, proportion of users purchasing a subscription, the estimated life-time value (LTV) of subscribers, and the mix of plans being purchased. An administrator may be permitted to define respective importance of the various collected metrics, such that a score is computed for each model, based on past performance of the model, with a given model's score determining the proportion of traffic that is to be directed to that model. An example subscription system is illustrated in FIG. 2.

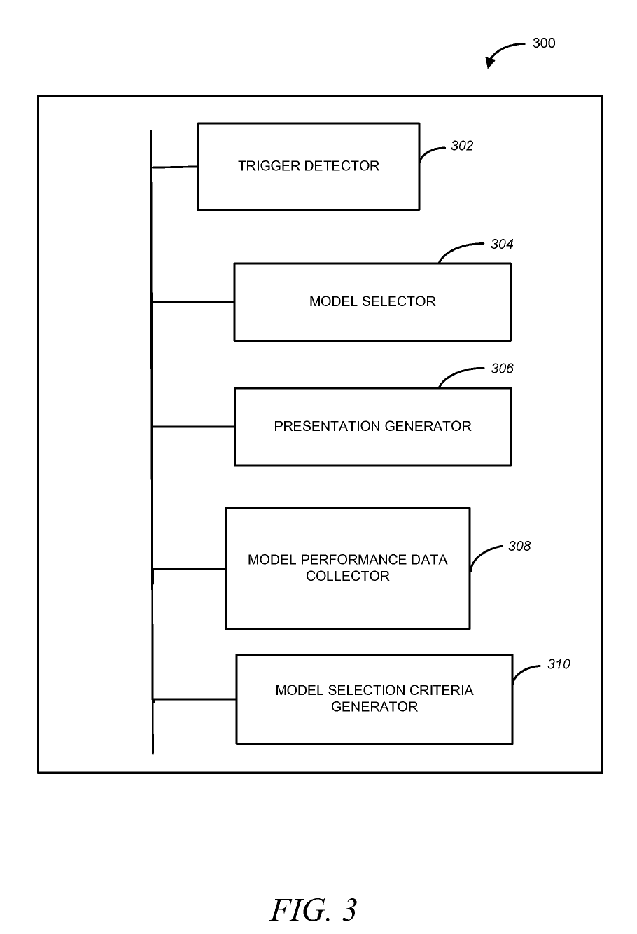

FIG. 2 is a block diagram of a subscription system 200, in accordance with one example embodiment. As shown in FIG. 2, the subscription system 200 includes choice presentation models 201, 202, and 203, a models mediator 204, and a communications module 206. The choice presentation models 201, 202, and 203 may be configured to take as input the user's profile data that was submitted by the user to the social networking website and, based on that data, select one or more subscription plans for presentation to the user. In addition to the user's profile data, a choice presentation model may utilize data related to a user's activity on the social networking website, the user's social graph information, etc. For example, if many people in a user's network choose plan A, then it may be reasonable to infer that the user is also likely to choose plan A. Similarly, if a user is a patent attorney, and all patent attorneys show a preference for plan A, then then it is reasonable to infer that the user is also likely to choose plan A. As mentioned above, a choice presentation model may utilize a rules-based approach or machine-learning techniques. The models mediator 204 may be implemented using software, hardware or both, and may be configured to exercise different choice presentation models, collect and analyze information with respect to how well each model performed in succeeding to convince a respective user to purchase one of the presented subscription plans, and determine how frequently each model should be used to generate a presentation of subscription choices. The models mediator 204 may be invoked in response to a so-called triggering event. As mentioned above, a triggering event may be any predetermined event on the associated social networking website that is considered as indicative of a user's potential interest in purchasing a subscription, such as, e.g., a user attempting to access a for-fee feature provide by the social networking website. The communications module 206 may be configured to communicate to a client system associated with the user a presentation of subscription choices generated by a choice presentation model selected by the models mediator 204. Some modules of the models mediator 204 may be described with reference to FIG. 3.

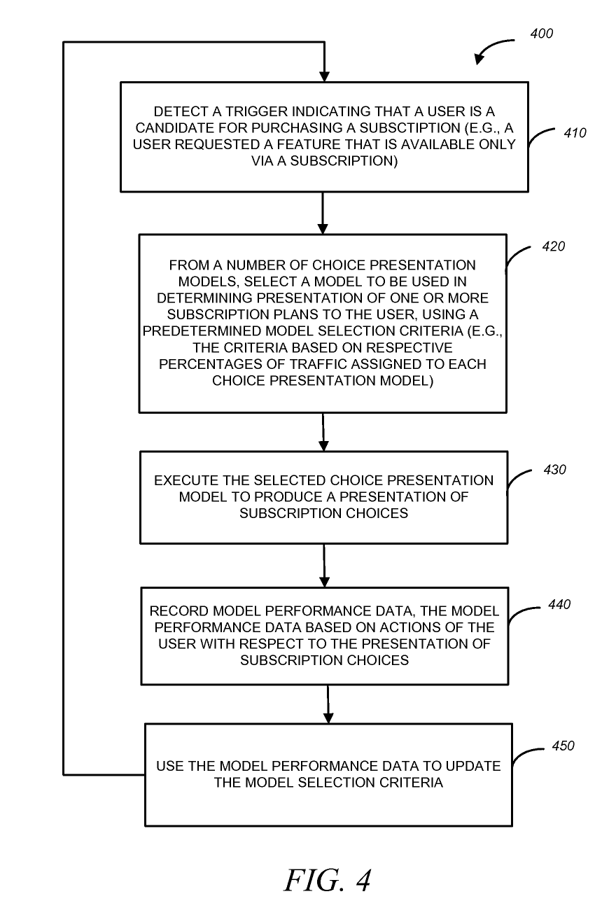

FIG. 3 is a block diagram of a system 300 to mediate selection of choice presentation models, in accordance with one example embodiment. As shown in FIG. 3, the system 300 includes a trigger detector 302, a model selector 304, a presentation generator 306, a model performance data collector 308, and a model selection criteria generator 310. The trigger detector 302 may be configured to detect a trigger event at a website. A trigger event may be associated with an activity of a user. The model selector 304 may be configured to select, using model selection criteria, a choice presentation model from a plurality of models to effectuate selection of subscription plans to be presented to the user. The presentation generator 306 may be configured to execute the choice presentation model to generate a presentation of subscription choices. The model performance data collector 308 may be configured to record model performance data, the model performance data based on actions of the user with respect to the presentation of subscription choices. The model selection criteria generator 310 may be configured to update the model selection criteria based on the model performance data. An example method to mediate selection of choice presentation models can be described with reference to FIG. 4.

FIG. 4 is a flow chart of a method 400 to optimize selection of subscription options, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the provider system 140 of FIG. 1 and, specifically, at the subscription system 200 shown in FIG. 2.

As shown in FIG. 4, the method 400 commences at operation 410, when the trigger detector 302 detects a trigger event at a website. The model selector 304 selects a choice presentation model from a plurality of models using model selection criteria to effectuate selection of subscription plans to be presented to the user, at operation 420. The distribution of traffic among models may be performed automatically and/or manually. As mentioned above, the metrics collected with respect to each model's performance may be weighted in light of one or more business objectives. The collected metrics and traffic directed to each model may be determined automatically as a function of each model's score.

At operation 430, the selected choice presentation model is executed and a presentation of subscription choices is generated. In one embodiment, the generating of a presentation of subscription choices may be performed such that the selection of subscription plans to be included in the presentation is a step separate from the determination of which features of the respective plans are to be emphasized to the user. The model performance data collector 308 records model performance data at operation 440. As explained above, the model performance data may be based on actions of the user with respect to the presentation of subscription choices. The model selection criteria generator 310 updates the model selection criteria based on the model performance data at operation 450. The method 400 continues in an iterative fashion, where the distribution of the traffic among the choice presentation models evolves as the performance of the models is being evaluated and the selection criteria is being updated accordingly.

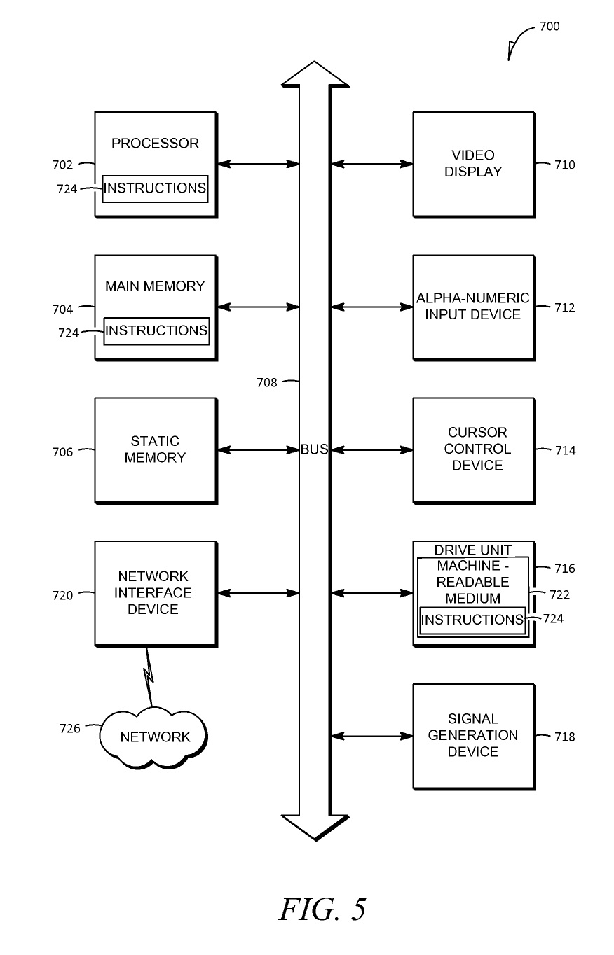

FIG. 5 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to mediate selection of choice presentation models has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

While the description above refers to using the techniques for optimizing selection of presentation of subscription plans in the context of a social networking website, the techniques described herein may be used beneficially with respect to other applications. These techniques may be used in any scenario where it may be useful to predict which particular set of choices is to be presented to a particular recipient in order to improve the likelihood of achieving a particular goal. For example, a method to mediate selection of choice presentation models may be used, e.g., in the context of a performance venue website, where users may be offered to purchase season tickets for concert series or in the context of an on-line car insurance website, where users are offered to select from different insurance coverage options. Other examples of the applications of a method to mediate selection of choice presentation models are where a user is offered selection of a primary care physician or a university selection for prospective students.

1. A method comprising:
detecting, using at least one processor, a trigger event at a website, the trigger event associated with an activity of a user;
selecting, using model selection criteria, using at least one processor, a choice presentation model from a plurality of models to effectuate selection of subscription plans to be presented to the user;
executing, using at least one processor, the choice presentation model to generate a presentation of subscription choices;
recording, using at least one processor, model performance data, the model performance data based on actions of the user with respect to the presentation of subscription choices; and
using the model performance data to update the model selection criteria, using at least one processor.

2. The method of claim 1, wherein the selection criteria comprises respective default percentages of triggering events to be handled by respective choice presentation models.

3. The method of claim 1, wherein executing of the choice presentation model comprises:
selecting one or more subscription plans form the plurality of subscription plans; and
determining an order in which the selected one or more subscription plans are to be arranged in the presentation of subscription choices.

4. The method of claim 1, wherein the executing of the choice presentation model comprises utilizing one or more predetermined rules.

5. The method of claim 1, wherein the executing of the choice presentation model comprises utilizing machine learning.

6. The method of claim 1, wherein the triggering event comprises detecting that the user requested a for-a-fee feature.

7. The method of claim 1, wherein the triggering event comprises detecting that the user requested a number of results that exceeds a default maximum number of results.

8. The method of claim 1, wherein the using of the model performance data to update the model selection criteria is to increase a likelihood of the user purchasing a subscription form the presentation of subscription choices.

9. The method of claim 1, wherein executing of the choice presentation model comprises utilizing one or more of profile information of the user and activities of the user at the website.

10. The method of claim 1, wherein the website is an on-line social networking website.

11. A computer-implemented system comprising:
at least one processor coupled to a memory;
a trigger detector to detect, using the at least one processor, a trigger event at a website, the trigger event associated with an activity of a user;
a model selector to select, the using at least one processor, using model selection criteria, a choice presentation model from a plurality of models to effectuate selection of subscription plans to be presented to the user;
a presentation generator to execute, using the at least one processor, the choice presentation model to generate a presentation of subscription choices;
model performance data collector to record model performance data, using the at least one processor, the model performance data based on actions of the user with respect to the presentation of subscription choices; and
a model selection criteria generator to update the model selection criteria, using the at least one processor, based on the model performance data.

12. The system of claim 11, wherein the selection criteria comprises respective default percentages of triggering events to be handled by respective choice presentation models.

13. The system of claim 11, wherein the choice presentation model is to:
select one or more subscription plans form the plurality of subscription plans; and
determine an order in which the selected one or more subscription plans are to be arranged in the presentation of subscription choices.

14. The system of claim 11, wherein the choice presentation model is a rules-based model.

15. The system of claim 11, wherein the executing of the choice presentation model is a machine learning model.

16. The system of claim 11, wherein the trigger detector is to detect that the user requested a for-a-fee feature.

17. The system of claim 11, wherein the trigger detector is to detect that the user requested a number of results that exceeds a default maximum number of results.

18. The system of claim 11, wherein the selection criteria is targeting an increase in a likelihood of the user purchasing a subscription form the presentation of subscription choices.

19. The system of claim 11, wherein the choice presentation model is to effectuate selection of subscription plans based on one or more of profile information of the user and activities of the user at the website.

20. A machine-readable non-transitory storage medium having instruction data to cause a machine to:
detect a trigger event at a website, the trigger event associated with an activity of a user;
select, using model selection criteria, a choice presentation model from a plurality of models to effectuate selection of subscription plans to be presented to the user;
a execute the choice presentation model to generate a presentation of subscription choices;
record model performance data, the model performance data based on actions of the user with respect to the presentation of subscription choices; and
update the model selection criteria based on the model performance data.
